(19) United States
(12) Patent Application Publication
(10) Pub. No.: US 2015/0237918 A1
(43) Pub. Date: Aug. 27, 2015

(54) BATTERY ASSEMBLY, ELECTRONIC CIGARETTE, AND WIRELESS CHARGING METHOD

(71) Applicant: Qiuming Liu, Shenzhen (CN)

(72) Inventor: Qiuming Liu, Shenzhen (CN)

(21) Appl. No.: 14/504,242

(22) Filed: Oct. 1, 2014

Related U.S. Application Data
(63) Continuation of application No. PCT/CN2014/072518, filed on Feb. 25, 2014.

(51) Int. Cl. A24F 47/00; H01M 2/10

(52) U.S. Cl. CPC A24F 47/008; H01M 2/1055; H01M 2220/30

(57) ABSTRACT

A battery assembly, an electronic cigarette and a wireless charging method are provided. The battery assembly comprises a battery case and a connecting member connected to an atomizing assembly; a battery is mounted in the battery case. The battery case is made of nonmetallic material; a metallic fixing sleeve is sheathed on the connecting member and inserted in the insertion end of the battery case; and a wireless charging device is mounted in the battery case. The present application achieves charging via the wireless connection method, doesn't require accurate physical locating, and achieves charging when the rechargeable battery assembly is put in the transmitting range of the electromagnetic wave of the external charger. The charging is easy to achieve, and the defect of the poor contact caused by the aging or polluted interface can't exist.

### CROSS-REFERENCE TO RELATED APPLICATION

This application is a continuation application of International Patent Application No. PCT/CN2014/072518, by Qiuming LIU, filed Feb. 25, 2014, which is hereby incorporated herein in its entirety by reference.

### FIELD OF THE INVENTION

The present application relates to the field of daily electronic products, and more particularly relates to a battery assembly, an electronic cigarette, and a wireless charging method.

### BACKGROUND OF THE INVENTION

An electronic cigarette comprises a battery assembly and an atomizing assembly. The atomizing assembly includes tobacco juice and an atomizing filament configured for generating heat and atomizing the tobacco juice when powered, and the battery assembly includes a battery configured to provide the voltage for atomizing.

In a rechargeable electronic cigarette, the battery of the battery assembly can be charged by a USB charger or an electronic cigarette case, etc. Conventional rechargeable electronic cigarettes usually adopt a contact charging method. Although the contact charging method is widely used and can be achieved by various ways, it requires accurate locations. Moreover, aging and pollution of component terminals may result in poor contacts, and thus the user experience may be bad.

FIG. 1 is a structural schematic view of a USB charger configured for charging a battery assembly in the prior art. A charging slot 40 is defined in the bottom portion of the USB charger. FIG. 2 is a structural schematic view of a battery assembly cooperating with the USB charger shown in FIG. 1 to achieve charging. The battery assembly includes a battery case 1′ made of metal and configured for accommodating a battery; a connecting member 15′ configured for connecting with an atomizing assembly is inserted in an end of the battery case 1′. When the battery assembly is charged, the atomizing assembly is separated from the battery assembly, and the connecting member 15′ can be inserted in the charging slot 40 of the USB charger to achieve charging. This charging method not only requires disassembling the electronic cigarette, but also requires the physical connection between the battery assembly and the charger to be accurately located. Moreover, there may be defects which result in poor contacts, such as aging, pollution, and so on, at the connection joints. In addition, when a user holds the metallic battery case 1′ to smoke, the user may feel cold and the battery case 1′ may be too heavy to the user, which may cause poor user experience. Thirdly, the elasticity of the metallic battery case 1′ is usually poor, and thus elements that need to be inserted in the battery case 1′ are not convenient to assemble.

Above all, the prior art has defects and needs to be improved.

### SUMMARY OF THE INVENTION

The objective of the present application is to provide a battery assembly that is convenient to use, provides good experience for users, and is easy to assemble, an electronic cigarette using the battery assembly, and a wireless charging method for the electronic cigarette, aiming at the defects that the aforementioned physical connection charging method in the prior art requires accurate locations, may form poor contact due to aging and pollution, has bad user experience, and is inconvenient to assemble.

The technical solutions of the present application for solving the technical problems are as follows.

In one aspect, a battery assembly configured for cooperating with an external charger to be wireless charged and assembling with an atomizing assembly to form an electronic cigarette is provided; the battery assembly comprises a battery case, and a connecting member inserted in an insertion end of the battery case and configured to be connected with the atomizing assembly; a battery is configured for charging the atomizing assembly and being mounted in the battery case; the battery case is made of nonmetallic material; a metallic fixing sleeve is sheathed on the connecting member and inserted in the insertion end of the battery case; and a wireless charging device is configured for receiving electromagnetic wave sent from the external charger, and further configured for charging the battery or supplying electric power to the atomizing assembly is mounted in the battery case.

In one embodiment, the wireless charging device comprises a magnetic induction assembly mounted on a side portion of the battery far away from the connecting member and a controller;

the magnetic induction assembly includes a second support, and a longitudinal section of the second support is I-shaped; the magnetic induction assembly further includes a coil winding on a middle portion of the second support; and the coil is configured for receiving the electromagnetic wave and generating an induction voltage;

the controller includes a control circuit electrically connected to the battery and a wireless charging management circuit connected to the coil, the battery, and the control circuit; and the wireless charging management circuit is configured for rectifying and filtering the induction voltage and providing a rectified and filtered voltage for charging the battery or supplying electric power to the atomizing assembly.

In another embodiment, a guiding groove extending along an axial direction of the connecting member and a fastening groove extending along a circumferential direction of the connecting member and communicating with the guiding groove are defined in an internal surface of the connecting member; and an elastic limiting portion configured for preventing the atomizing assembly from rotating is mounted in the fastening groove.

In another embodiment, a protecting sleeve is mounted in the battery case; the protecting sleeve is made of nonmetallic material; an end of the battery case far away from the connecting member radially extends towards a central axis of the battery case to form an internal flange; the protecting sleeve is resisted between the fixing sleeve and the internal flange; an end surface of the fixing sleeve far away from the protecting sleeve is flush with an end surface of the battery case; one part of the connecting member is accommodated in the fixing sleeve, and another part of the connecting member is accommodated in the protecting sleeve.

In another embodiment, an axis of the coil is parallel to the central axis of the battery case; and the second support is made of ferrite.

In another embodiment, the wireless charging device comprises a magnetic induction assembly mounted on a side portion of the battery far away from the connecting member and a controller;

the magnetic induction assembly includes a cylindrical second support and a coil winding along a circumferential direction of an external surface of the second support; and the coil is configured for receiving the electromagnetic wave and generating an induction voltage;

the controller includes a control circuit electrically connected to the battery and a wireless charging management circuit connected to the coil, the battery, and the control circuit; and the wireless charging management circuit is configured for rectifying and filtering the induction voltage and providing a rectified and filtered voltage for charging the battery or supplying electric power to the atomizing assembly.

In another embodiment, the controller includes an integrated control chip, and the model of the integrated control chip is SG88602; the control circuit and the wireless charging management circuit are integrated in the integrated control chip; a CHG pin of the integrated control chip and a GND pin of the integrated control chip are respectively connected to two terminals of the coil; a VDD pin of the integrated control chip is connected to the anode of the battery, and a GND pin of the integrated control chip is connected to the cathode of the battery.

In another embodiment, the wireless charging management circuit includes a charging management chip, a rectifier diode, and a filter capacitor; and the model of the charging management chip is VA7204;

one terminal of the coil is connected to the anode of the rectifier diode, and the other terminal of the coil is connected to the GND pin of the charging management chip; the cathode of the rectifier diode is connected to the VCC pin of the charging management chip; and the cathode of the rectifier diode is further grounded via the filter capacitor.

In another embodiment, the control circuit includes a microprocessor, a triode, a LED lamp configured for shining to indicate that the wireless connection between the battery assembly and the external charger is normal, and a buzzer configured for generating sounds to indicate that the wireless connection between the battery assembly and the external charger is normal;

the anode of the LED lamp is connected to the cathode of the rectifier diode via a resistor; the anode of the LED lamp is further connected to the microprocessor; the cathode of the LED lamp is grounded; the anode of the buzzer is connected to the cathode of the rectifier diode, and the cathode of the buzzer is connected to the emitter of the triode; the base of the triode is connected to the microprocessor, and the collector of the triode is grounded.

In another embodiment, the battery assembly further includes a charging switch mounted on the battery case and connecting the wireless charging management circuit with the battery; the charging switch is configured for starting a wireless charging function of the battery assembly.

In another aspect, an electronic cigarette comprising an atomizing assembly and a battery assembly is provided; the battery assembly is configured for cooperating with an external charger to achieve wireless charging; the battery assembly comprises a battery case and a connecting member inserted in an insertion end of the battery case, and is configured to be connected with the atomizing assembly; a battery is configured for charging the atomizing assembly and being mounted in the battery case; the battery case is made of nonmetallic material; a metallic fixing sleeve is sheathed on the connecting member and inserted in the insertion end of the battery case; and a wireless charging device configured for receiving electromagnetic wave sent from the external charger, and further configured for charging the battery or supplying electric power to the atomizing assembly is mounted in the battery case.

In one embodiment, the wireless charging device comprises a magnetic induction assembly mounted on a side portion of the battery far away from the connecting member and a controller;

the magnetic induction assembly includes a second support, and a longitudinal section of the second support is I-shaped; the magnetic induction assembly further includes a coil winding on a middle portion of the second support; and the coil is configured for receiving the electromagnetic wave and generating an induction voltage;

the controller includes a control circuit electrically connected to the battery and a wireless charging management circuit connected to the coil, the battery and the control circuit; and the wireless charging management circuit is configured for rectifying and filtering the induction voltage and providing a rectified and filtered voltage for charging the battery or supplying electric power to the atomizing assembly.

In another embodiment, a fastener is mounted on a peripheral surface of an end portion of the atomizing assembly; a guiding groove extending along an axial direction of the connecting member and a fastening groove extending along a circumferential direction of the connecting member and communicating with the guiding groove are defined in an internal surface of the connecting member; the fastener is inserted in the fastening groove, and an elastic limiting portion configured for preventing the atomizing assembly from rotating is mounted in the fastening groove; when the electronic cigarette is assembled, the fastener of the atomizing assembly is inserted in the guiding groove, and when the fastener reaches the connection point of the guiding groove and the fastening groove, the atomizing assembly is rotated so that the fastener enters the fastening groove.

In another embodiment, a protecting sleeve is mounted in the battery case; the protecting sleeve is made of nonmetallic material; an end of the battery case far away from the connecting member radially extends towards a central axis of the battery case to form an internal flange; the protecting sleeve is resisted between the fixing sleeve and the internal flange; an end surface of the fixing sleeve far away from the protecting sleeve is flush with an end surface of the battery case; one part of the connecting member is accommodated in fixing sleeve, and another part of the connecting member is accommodated in the protecting sleeve.

In another embodiment, the controller includes an integrated control chip, and the model of the integrated control chip is SG88602; the control circuit and the wireless charging management circuit are integrated in the integrated control chip; a CHG pin of the integrated control chip and a GND pin of the integrated control chip are respectively connected to two terminals of the coil; a VDD pin of the integrated control chip is connected to the anode of the battery, and a GND pin of the integrated control chip is connected to the cathode of the battery.

In another embodiment, the wireless charging management circuit includes a charging management chip, a rectifier diode, and a filter capacitor; and the model of the charging management chip is VA7204;

one terminal of the coil is connected to the anode of the rectifier diode, and the other terminal of the coil is connected to the GND pin of the charging management chip; the cathode of the rectifier diode is connected to the VCC pin of the charging management chip; and the cathode of the rectifier diode is further grounded via the filter capacitor.

In another aspect, a wireless charging method configured for charging a battery assembly is provided; the wireless charging method comprises: putting the battery assembly in a transmission range of electromagnetic wave sent from an external charger; receiving the electromagnetic wave from the external charger by a wireless charging device mounted in a battery case and charging a battery or supplying electric power to an atomizing assembly by the wireless charging device.

In one embodiment, receiving the electromagnetic wave from the external charger by the wireless charging device and charging the battery or supplying electric power to the atomizing assembly by the wireless charging device includes: receiving the electromagnetic wave by a coil of a magnetic induction assembly, and generating an induction voltage by the coil; rectifying and filtering the induction voltage by a wireless charging management circuit of a controller, and providing a rectified and filtered voltage for charging the battery or supplying electric power to the atomizing assembly by the wireless charging management circuit.

In another embodiment, the wireless charging method further comprises: turning on a charging switch mounted on the battery case before starting a wireless charging function of the battery assembly.

In another embodiment, the wireless charging method further comprises: after the battery assembly is put in the transmission range of the electromagnetic wave sent from the external charger, if the wireless connection between the battery assembly and the external charger is normal, starting to charge the battery or supplying the atomizing assembly with the electric power, and indicating the normal wireless connection by shining and/or making sounds.

When implementing the battery assembly, the electronic cigarette, and a wireless charging method of the present application, the following advantageous effects can be achieved: the wireless charging device configured for receiving the electromagnetic wave sent from the external charger, and further charging the battery or supplying electric power to the atomizing assembly is added in the battery case. Correspondingly, the battery case is made of nonmetallic material, which is convenient for the electromagnetic wave to pass through. Moreover, as the battery case is made of nonmetallic material, the weight of the battery assembly is reduced, the battery case feels soft, and the user experience is improved. The elasticity of the battery case is good, so that elements that need to be inserted in the battery case are convenient to assemble. The metallic fixing sleeve is sheathed on the connecting member and is inserted in one end of the battery case, which improves the connection stability between the connection member and the battery assembly, prevents the connecting member from separating from the battery case, and has high reliability. The present application charges using the wireless connection method, doesn't require accurate physical locations, and can achieve the charging effect as long as the rechargeable battery assembly is put in the transmission range of the electromagnetic wave from the external charger. The charging process is easy to achieve, the electronic cigarette doesn't need to be disassembled, and the defect of the poor contact caused by aging or pollution of the interface can't exist.

### BRIEF DESCRIPTION OF THE DRAWINGS

The present application will be further described with reference to the accompanying drawings and embodiments in the following, in the accompanying drawings:

FIG. 1 is a structural schematic view of a USB charger configured for charging a battery assembly in the prior art;

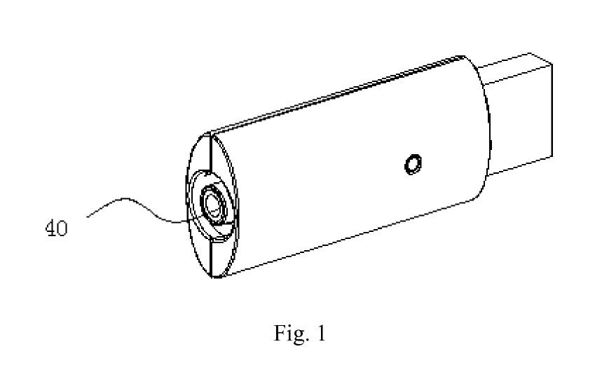

FIG. 2 is a structural schematic view of a battery assembly cooperating with the USB charger shown in FIG. 1 to charge;

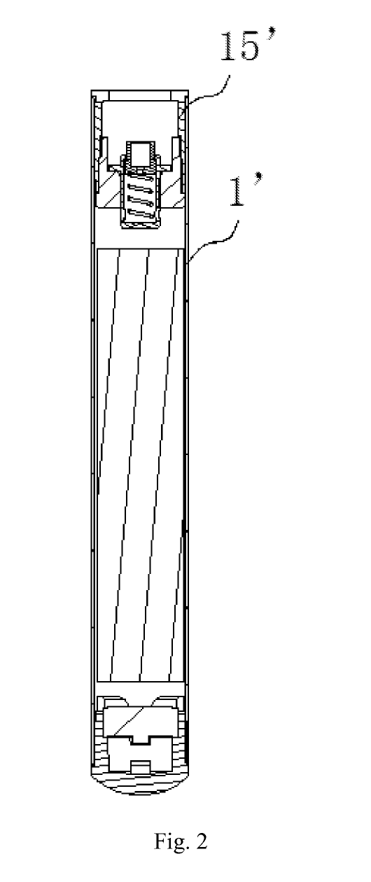

FIG. 3 is a structural schematic view of a first embodiment of an electronic cigarette of the present application, wherein an atomizing assembly of the electronic cigarette is separated from a battery assembly of the electronic cigarette;

FIG. 4 is an exploded view of the battery assembly shown in FIG. 3;

FIG. 5 is a 3D assembly structural view of the battery assembly shown in FIG. 4;

FIG. 6 is a structural schematic view of a second embodiment of the battery assembly of the present application;

FIG. 7 is an exploded view of the battery assembly shown in FIG. 6;

FIG. 8 is a 3D assembly structural view of a magnetic induction assembly shown in FIG. 7;

FIG. 9 is a circuit block diagram of a battery assembly of the present application that is wirelessly connected to an external charger and charged;

FIG. 10 is a circuit diagram of a first embodiment of a wireless charging management circuit and a control circuit of the battery assembly of the present application;

FIG. 11 is a circuit diagram of a second embodiment of a wireless charging management circuit and a control circuit of the battery assembly of the present application.

### DETAILED DESCRIPTION OF THE PREFERRED EMBODIMENT

The objective of the present application is to provide a battery assembly, an electronic cigarette, and a wireless charging method, aiming at the defects that the physical connection charging method in the prior art requires accurate locations, may form poor contact due to aging and pollution, has bad user experience, and is inconvenient to assemble. In the battery assembly and the electronic cigarette of the present application, a wireless charging device configured for receiving electromagnetic wave sent from an external charger and further charging a battery or supplying electric power to the atomizing assembly is added in the battery case. Correspondingly, the battery case is made of nonmetallic material, which is convenient for the electromagnetic wave to pass through. Moreover, as the battery case is made of nonmetallic material, the weight of the battery assembly is reduced, the user experience is improved, the reliability is high, and the assembly is convenient. The present application charges via a wireless connection method and doesn't require accurate physical locations. If only a rechargeable battery assembly is put in a transmission range of the electromagnetic wave sent from the external charger, the charging process can be achieved. Thus, the charging process is simple and easy, the electronic cigarette doesn't need to be disassembled, and the defect of the poor contact caused by aging or pollution of a connecting interface can't exist.

To make the technical feature, objective and effect of the present application be understood more clearly, now the specific implementation of the present application is described in detail with reference to the accompanying drawings and embodiments.

A battery assembly of the present application is configured for cooperating with an external charger to achieve wireless charging, and is also configured for assembling with an atomizing assembly to form an electronic cigarette. The battery assembly comprises a battery case and a connecting member inserted in an insertion end of the battery case and configured to be connected with the atomizing assembly. A battery configured for charging the atomizing assembly is mounted in the battery case. The battery case is made of nonmetallic material; a metallic fixing sleeve is sheathed on the connecting member and inserted in the insertion end of the battery case; and a wireless charging device configured for receiving electromagnetic wave sent from the external charger, and further charging the battery or supplying electric power to the atomizing assembly is mounted in the battery case.

### The First Embodiment

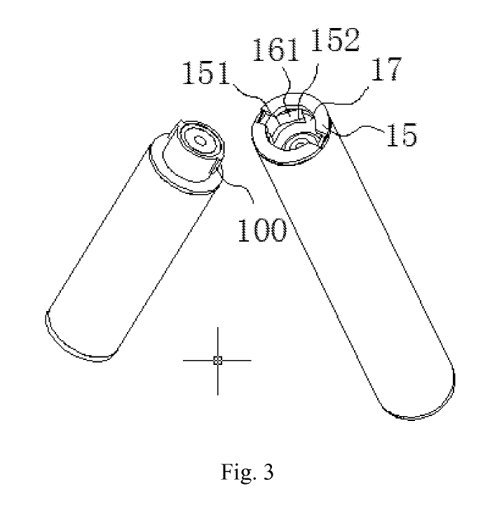

As shown in FIGS. 3-5, in this embodiment, the battery assembly comprises a battery case 1 and a connecting member 15 inserted in an insertion end of the battery case 1 and configured to be connected with an atomizing assembly. In an electronic cigarette in the prior art, the connecting member 15 is exposed by detaching the atomizing assembly, and then cooperates with a charging slot of a charger to achieve charging. This charging method requires disassembling the electronic cigarette, and is inconvenient.

In the present application, the battery case 1 is made of nonmetallic material. Thus, the battery case 1 feels soft, comfortable and light, which is convenient for simulating a touch of a real cigarette, improves the whole simulation degree of the electronic cigarette significantly, optimizes the use feeling of users significantly, and avoids drop of the connecting member 15. As the battery case 1 is made of nonmetallic material, the stability and the reliability of an assembly structure of a battery using the battery case 1 may be degraded; therefore, in order to make the assembly structure of the battery using the battery case 1 be more stable and reliable, advantageously, a metallic fixing sleeve 13 is sheathed on the connecting member 15 and inserted in the insertion end of the battery case 1. As the fixing sleeve 13 is made of metallic material, when the fixing sleeve 13 is connected to the atomizing assembly, the structure is more stable, and the fixing sleeve 13 can be disassembled from the atomizing assembly conveniently.

A guiding groove 151 extending along an axial direction of the connecting member 15 and a fastening groove 152 extending along a circumferential direction of the connecting member 15 and communicating with the guiding groove 151 are defined in an internal surface of the connecting member 15. An elastic limiting portion 161 configured for preventing the atomizing assembly from rotating is mounted in the fastening groove 152. Specifically, a through-hole 153 is defined in a side surface of the connecting member; a U-shaped metallic elastic plate 16 is mounted on an outer surface of the connecting member 15. The elastic limiting portion 161 passing through the through-hole 153 and extending into the fastening groove 152 is mounted on the metallic elastic plate 16. A first support 17 is mounted in the connecting member 15, and a gap 171 corresponding to the guiding groove 151 and the elastic limiting portion 161 is defined in an end surface of the first support 17. Of course, the elastic limiting portion 161 can also be integrated with the connecting member 15, and is not limited thereof.

The battery assembly further includes a battery 2 configured for supplying electric power to the atomizing assembly and a wireless charging device, which are both mounted in the battery case 1 and orderly arranged from the insertion end of the battery case 1 abutting the connecting member 15 and along an axial direction of the battery case 1. A lamp cap 11 is inserted in an end portion of the battery case 1 far away from the connecting member 15. The wireless charging device specifically comprises a magnetic induction assembly 4 mounted on a side portion of the battery 2 far away from the connecting member 15, and a controller 3.

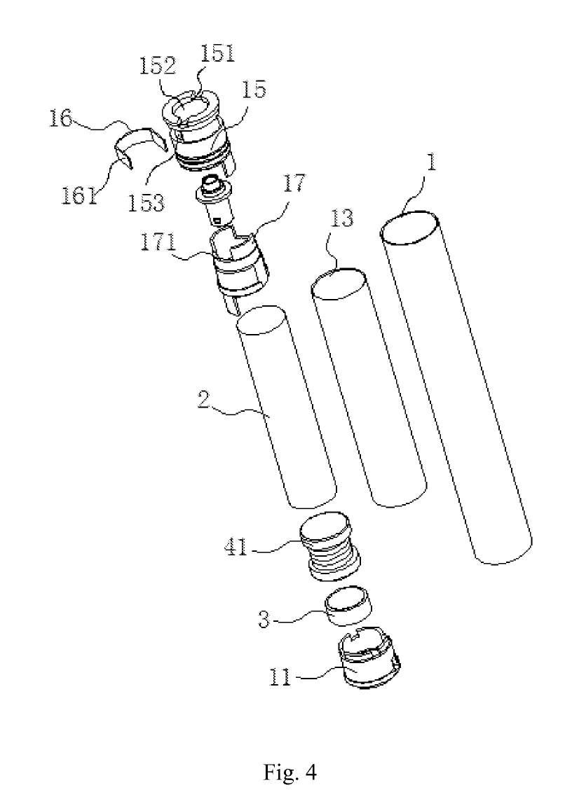

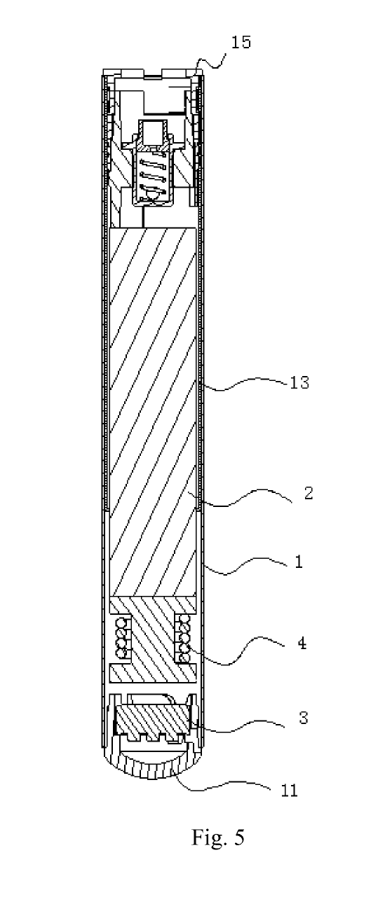

As shown in FIGS. 4 and 5, the magnetic induction assembly 4 includes a second support 41, and a longitudinal section of the second support 41 is I-shaped. The magnetic induction assembly 4 further includes a coil winding on a middle portion of the second support 41, and the coil is configured for receiving the electromagnetic wave and generating an induction voltage. An axis of the coil is parallel to the central axis of the battery case 1, and the second support 41 is made of ferrite. An end surface of the second support 41 resists against the battery 2, and another end surface of the second support 41 far away from the battery 2 is disposed to face the controller 3. Specifically, the second support 41 includes a cylindrical support body, and two circumferential side edges of two end surfaces of the support body radially extend away from the central axis of the support body to form two external flanges respectively. The coil winds on the cylindrical support body. In this embodiment, as the electromagnetic wave sent from the charger can be led into the support body via the two external flanges of the I-shaped structure, the overall energy transmission efficiency can be higher. As the coil generates changing electromagnetic wave therein, the induction voltage is generated. A wireless charging management circuit can process (e.g., rectify, filter, and stabilize) the induction voltage, and provide a processed voltage to charge the battery 2 or supply electric power to the atomizing assembly.

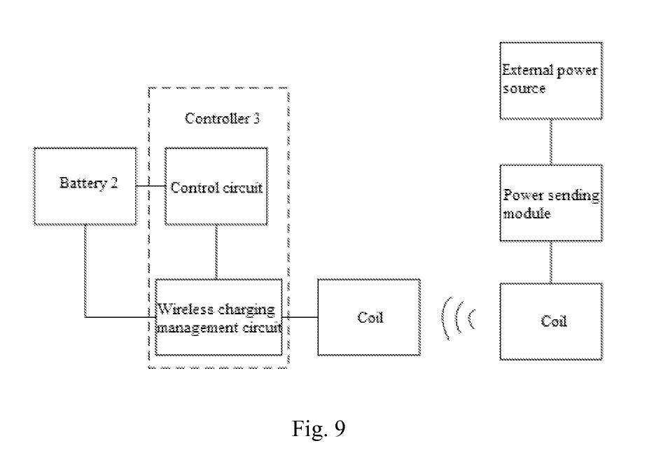

As shown in FIG. 9, the controller 3 includes a control circuit electrically connected to the battery 2 and a wireless charging management circuit connected to the coil, the battery 2, and the control circuit. The wireless charging management circuit is configured for rectifying and filtering the induction voltage and providing the rectified and filtered voltage to charge the battery 2 or supply electric power to the atomizing assembly. The control circuit is configured for controlling the atomizing work of the atomizing assembly. When the control circuit is connected to the atomizing assembly, that is, the connecting member of the atomizing assembly is correspondingly connected to the connecting member 15 of the battery assembly, the electrical connection between the battery 2 and the connecting member 15 is achieved, so that the atomizing assembly is supplied with electric power under the control of the control circuit.

When the battery assembly is charged, the battery assembly is put in a transmission range of the electromagnetic wave sent from the external charger; the electromagnetic wave sent from the external charger goes through a nonmetallic material portion of the battery case 1 corresponding to the magnetic induction assembly 4, and is received by the coil of the magnetic induction assembly 4. The external charger should have a function of identifying charged products, otherwise, the external charger will transmit energy to any metal objects nearby and may cause the metal objects to generate heat, which is dangerous. In order that the electromagnetic wave goes through the battery case 1, the whole battery case 1 is made of nonmetallic material, such as plastic, rubber and paper material, etc.

The battery 2 can be partially or entirely accommodated in the fixing sleeve 13. In the first embodiment, an axial length of the fixing sleeve 13 is long, so that the battery 2 is entirely accommodated in the fixing sleeve 13. Thus, both the stability of the connecting member 15 and the stability of the assembly structure of the battery 2 can be improved by the fixing sleeve 13.

Specifically, the fixing sleeve 13 is located at a side of the magnetic induction assembly 4 facing the battery 2, the battery 2 is partially accommodated in the fixing sleeve 13, so that the metallic material portion of the fixing sleeve 13 does not prevent the electromagnetic wave from passing through, and an end surface of the fixing sleeve 13 far away from the magnetic induction assembly 4 is flush with an end surface of the battery case 1. Compared with steel pipes acting as battery cases in the prior art, the length of the battery case is only configured for accommodating elements of the magnetic induction assembly 4 facing the battery 2. Therefore, the weight of the battery case is reduced, and elements that may be detached from the atomizing assembly frequently are all accommodated in the fixing sleeve 13, so that the stability and the reliability of the assembly structure in the prior art can be maintained. On the basis that the electromagnetic wave can pass through the fixing sleeve 13, on one hand, the stability and the reliability of the assembly structure can be improved; on the other hand, the battery case 1 is made of plastic material and feels soft, comfortable and light, which is good for simulating a touch of a real cigarette, improves the whole simulation degree of the electronic cigarette significantly, and optimizes the use feeling of users significantly.

Advantageously, the battery assembly further includes a charging switch (not shown in the figures) mounted on the battery case 1 and connecting the wireless charging management circuit with the battery 2; the charging switch is configured for starting a wireless charging function of the battery assembly. If the battery of the battery assembly should be charged, the charging switch should be turned on firstly, so as to avoid that the battery assembly is charged improperly when the battery assembly approaches the external charger but indeed doesn't need to be charged.

### The Second Embodiment

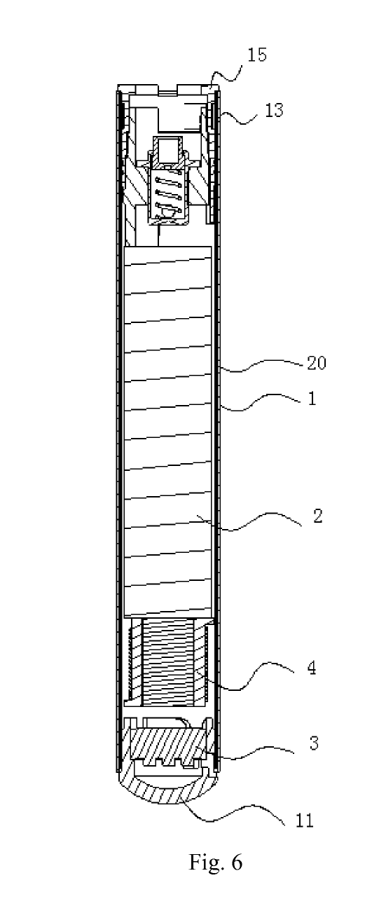

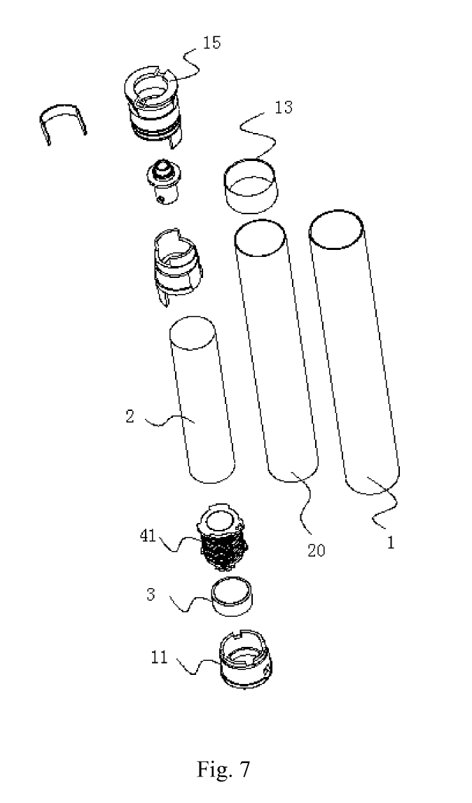

As shown in FIGS. 6 and 7, there are two different features between the second embodiment and the first embodiment. One of the different features is the length of the fixing sleeve 13, and the other is the structure of the second support 41 of the magnetic induction assembly 4.

About the fixing sleeve 13, in the first embodiment, an axial length of the fixing sleeve 13 is longer, so that the battery 2 can be accommodated in the fixing sleeve 13. In the second embodiment, the axial length of the fixing sleeve 13 is shorter, so the fixing sleeve 13 is only used for firming the assembly structure of the connecting member 15. A protecting sleeve 20 is mounted in the battery case 1 to firm the assembly structure of the battery 2. The protecting sleeve 20 is made of nonmetallic material. As shown in FIG. 6, an end of the battery case 1 far away from the connecting member 15 radially extends towards a central axis of the battery case 1 to form an internal flange, and the protecting sleeve 20 is resisted between the fixing sleeve 13 and the internal flange; an end surface of the fixing sleeve 13 far away from the protecting sleeve 20 is flush with an end surface of the battery case 1, one part of the connecting member 15 is accommodated in fixing sleeve 13, and another part of the connecting member 15 is accommodated in the protecting sleeve 20. Thus, in the second embodiment, the fixing sleeve 13 is only used for firming the assembly structure of the connecting member 15, and the assembly structure of the battery 2 is firmed by the protecting sleeve 20.

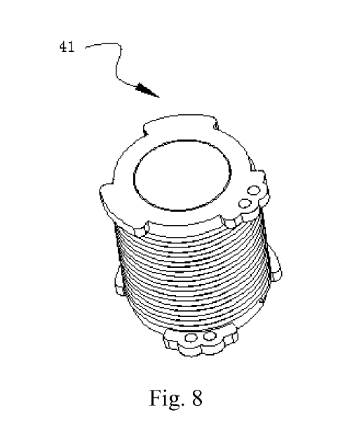

About the second support 41, as shown in FIG. 8, in the second embodiment, the magnetic induction assembly 4 includes a cylindrical second support 41 and a coil winding a circumferential external surface of the second support 41. An axis of the coil is parallel to the central axis of the battery case 1, and the second support 41 is made of ferrite.

An end surface of the second support 41 resists the battery 2, and an end surface of the second support 41 far away from the battery 2 is located to face the controller 3. Both two opposite ends of the second support 41 is provided with several protuberances radially extending away from the central axis of the second support 41 and configured for fixing the coil. In assembly, the second support 41 is pushed into the battery case 1, and the protuberances resist an internal surface of the battery case 1. In the second embodiment, each of the two opposite ends of the second support 41 is provided with three protuberances spaced with each other uniformly. The protuberances resist the battery case 1 respectively, so that the magnetic induction assembly 4 is mounted in the battery case 1 firmly. Thus, the magnetic induction assembly 4 can't move relative to the battery case 1 during use processes and transmission processes, and the signal induction sensitivity of the magnetic induction assembly 4 can be ensured. In addition, in order to reinforce the stability between the second support 41 and the battery case 1, projections of the protuberances on the two opposite ends of the second support 41 on a cross section of the battery case 1 are located at vertexes of a regular hexagon respectively. The second support 41 is cylindrical, therefore, the area of the coil is inevitably increased, and the induction current is increased. On the other hand, the second support 41 is hollow, which reduces the weight of the second support 41.

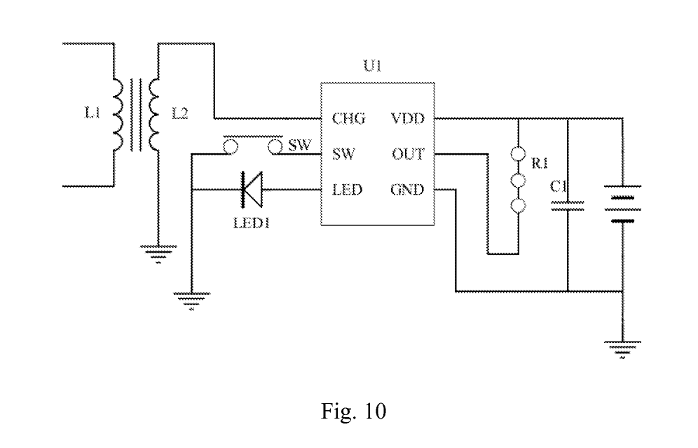

Accompanying with FIG. 9, FIG. 10 is a circuit diagram of a first embodiment of a wireless charging management circuit and a control circuit of the battery assembly of the present application.

In the first embodiment, the control circuit and the wireless charging management circuit are integrated in a chip. Specifically, the controller 3 includes an integrated control chip U1, a capacitor C1, a smoking switch SW, and a LED lamp LED1; the model of the integrated control chip U1 is SG88602, and the control circuit and the wireless charging management circuit are integrated in the integrated control chip U1. The atomizing assembly includes a heating filament R1.

A CHG pin and a GND pin of the integrated control chip U1 are respectively connected to two terminals of the coil L1, a VDD pin of the integrated control chip U1 is connected to the anode of the battery 2, and the GND pin of the integrated control chip U1 is further connected to the cathode of the battery 2. A SW pin of the integrated control chip U1 is grounded via the smoking switch SW, an LED pin of the integrated control chip U1 is connected to the anode of the LED lamp LED1, and the cathode of the LED lamp LED1 is grounded. The smoking switch SW is an air flow sensor integrated in the controller 3. Of course, the smoking switch SW can also be a button disposed on the battery case 1, which is a prior art and is not detailed here. The LED lamp LED1 is configured for indication of charging and smoking. The heating filament R1 is connected between the VDD pin of the integrated control chip U1 and an OUT pin of the integrated control chip U1, and the capacitor C1 is connected between the anode of the battery 2 and the cathode of the battery 2.

The working process is as follows: the battery assembly is put in the transmission range of the electromagnetic wave sent from the external charger, the electromagnetic wave sent by the coil L1 of the external charger passes through the nonmetallic material portion of the battery case 1 corresponding to the magnetic induction assembly 4. The coil L2 of the magnetic induction assembly 4 receives the electromagnetic wave and generates the induction voltage. The induction voltage is rectified and filtered the induction voltage by the wireless charging management circuit of the integrated control chip U1, and the rectified and filtered voltage is output from the VDD pin to charge the battery 2. Meanwhile, a high level signal is output by the LED pin of the integrated control chip U1 and drives the LED lamp LED 1 to light for indication. If the smoking switch SW is triggered at this time, and the SW pin receives a low electric level or a high electric level of a smoking signal and detects a changed current signal, the control circuit of the integrated control chip U1 drives the OUT pin to output a certain voltage to supply electric power to the atomizing assembly and thereby heat the heating filament R1.

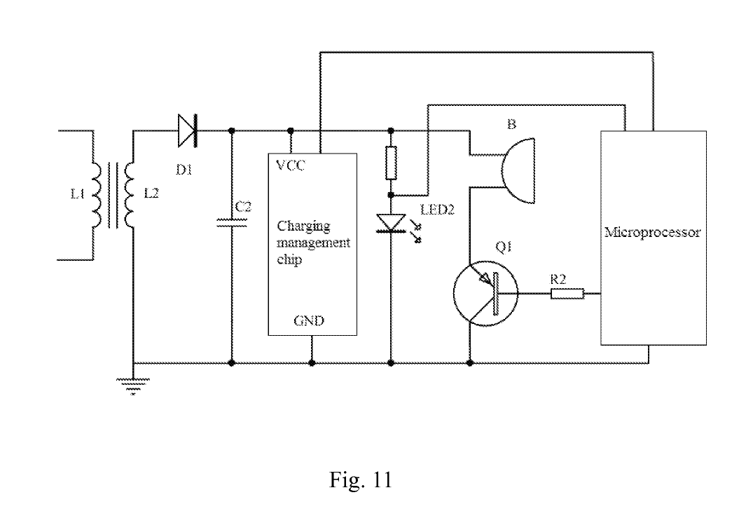

Accompanying with FIG. 9, FIG. 11 is a circuit diagram of a second embodiment of a wireless charging management circuit and a control circuit of the battery assembly of the present application.

In the second embodiment, the wireless charging management circuit includes a charging management chip, a rectifier diode D1, and a filter capacitor C2, and the model of the charging management chip is VA7204. The control circuit includes a microprocessor, a LED lamp LED2 configured for indicating that the wireless connection between the battery assembly and the external charger is normal by lighting, a PNP triode Q1, and a buzzer B configured for indicating that the wireless connection between the battery assembly and the external charger is normal by making sounds.

One terminal of the coil L2 is connected to the anode of the rectifier diode D1, and the other terminal of the coil L2 is connected to the GND pin of the charging management chip. The cathode of the rectifier diode D1 is connected to the VCC pin of the charging management chip. A BAT pin (not shown in figures) of the charging management chip is connected to the anode of the battery 2. The cathode of the rectifier diode D1 is further grounded via the filter capacitor C2. The charging management chip is further connected to the microprocessor.

The anode of the LED lamp LED2 is connected to the microprocessor, and the anode of the LED lamp LED2 is further connected to the cathode of the rectifier diode D1 via a resistor (not labeled). The cathode of the LED lamp LED2 is grounded. The anode of the buzzer B is connected to the cathode of the rectifier diode D1, and the cathode of the buzzer B is connected to the emitter of the triode Q1. The base of the triode Q1 is connected to the microprocessor via a resistor R2, and the collector of the triode Q1 is grounded.

Differing from the first embodiment, the coil L2 receives the electromagnetic wave and generates the induction voltage, the induction voltage is rectified by the rectifier diode Dl and filtered by the filter capacitor C2, the rectified and filtered voltage is output to the VCC pin of the charging management chip, and then the BAT pin of the charging management chip outputs charging current to the battery 2. Meanwhile, the anode of the LED lamp LED2 is at a high electric level, and the LED lamp LED2 is lighting. When the microprocessor detects that the anode of the LED lamp LED2 is at the high electric level, the microprocessor determines that the wireless connection between the battery assembly and the external charger is normal and the charging management chip has started to charge the battery 2. An IO interface of the microprocessor outputs PWM signals at different frequencies as required to the base of the triode Q1, and the triode Q1 is periodically turned on according to the frequency of the PWM signal, so that the buzzer B generates different indicating sounds for indicating that the wireless connection between the battery assembly and the external charger is good and the battery assembly is being charged. If a smoking switch (not shown in Figures) connected to another IO interface of the microprocessor is triggered, the microprocessor drives a switch (not shown in Figures) connected to the atomizing assembly to be turned on, and the atomizing assembly starts the atomizing work.

The present application further provides an electronic cigarette, and the electronic cigarette comprises an atomizing assembly and the aforementioned battery assembly. A fastener 100 is mounted on a circumferential surface of an end portion of the atomizing assembly. The fastener 100 is inserted in the fastening groove 152, and an elastic limiting portion 161 configured for preventing the atomizing assembly from rotating is mounted in the fastening groove 152. When the electronic cigarette is assembled, the fastener 100 of the atomizing assembly is inserted into the guiding groove 151. When the fastener 100 reaches the connection point between the guiding groove 151 and the fastening groove 152, the atomizing assembly is rotated so that the fastener 100 enters the fastening groove 152. The electronic cigarette of present application can make the connection between the atomizing assembly and the battery assembly be more convenient, and can prevent the problem that atomizing assembly may be separated from the battery assembly when the atomizing assembly is rotated because of shaking, compact, and vibration, etc.

Basing on the aforementioned battery assembly and the electronic cigarette, the present application further provides a wireless charging method configured for charging the battery assembly. The wireless charging method comprises: putting the battery assembly in the transmission range of the electromagnetic wave sent from the external charger; receiving the electromagnetic wave from the external charger by the wireless charging device mounted in the battery case 1 and further charging the battery 2 or supplying electric power to the atomizing assembly by the wireless charging device, which specifically includes: receiving the electromagnetic wave and generating the induction voltage by the coil of the magnetic induction assembly 4; rectifying and filtering the induction voltage by the wireless charging management circuit of the controller 3, and providing the rectified and filtered voltage for charging the battery 2 or supplying electric power to the atomizing assembly. If the wireless connection between the battery assembly and the external charger is normal, and the battery 2 is charged or the atomizing assembly is supplied with electric power, the LED lamp LED2 is lighting for indication, and/or the microprocessor drives the buzzer B to generate sounds for indication.

The wireless charging method further comprises: turning on a charging switch mounted on the battery case 1 before starting the wireless charging function of the battery assembly.

Above all, in the battery assembly and the electronic cigarette of the present application, the wireless charging device configured for receiving the electromagnetic wave sent from the external charger, and further charging the battery or supplying electric power to the atomizing assembly is added in the battery case. Correspondingly, the battery case is made of nonmetallic material, which is convenient for the electromagnetic wave to pass through. Moreover, as the battery case is made of nonmetallic material, the weight of the battery assembly is reduced, the battery case feels soft, and the user experience is improved. The elasticity of the battery case is good, so that elements that need to be inserted in the battery case are convenient to assemble. The metallic fixing sleeve is sheathed on the connecting member and inserted in one end of the battery case, which improves the connection stability between the connection member and the battery assembly, prevents that the connecting member from separating from the battery case, and has high reliability. The present application charges using the wireless connection method, doesn't require accurate physical locations, and can achieve the charging effect as long as the rechargeable battery assembly is put in the transmission range of the electromagnetic wave from the external charger. The charging is easy to achieve, the electronic cigarette doesn't need to be disassembled, and the defect of the poor contact caused by aging or pollution of the interface can't exist.

While the embodiments of the present application are described with reference to the accompanying drawings above, the present application is not limited to the above-mentioned specific implementations. In fact, the above-mentioned specific implementations are intended to be exemplary not to be limiting. In the inspiration of the present application, those ordinary skills in the art can also make many modifications without breaking away from the subject of the present application and the protection scope of the claims. All these modifications belong to the protection of the present application.

What is claimed is:

1. A battery assembly configured for cooperating with an external charger to be wireless charged and assembling with an atomizing assembly to form an electronic cigarette; the battery assembly comprising a battery case and a connecting member inserted in an insertion end of the battery case and configured to be connected with the atomizing assembly; a battery configured for charging the atomizing assembly and being mounted in the battery case; wherein, the battery case is made of nonmetallic material; a metallic fixing sleeve is sheathed on the connecting member and inserted in the insertion end of the battery case; and a wireless charging device is configured for receiving electromagnetic wave sent from the external charger, and further configured for charging the battery or supplying electric power to the atomizing assembly is mounted in the battery case.

2. The battery assembly according to claim 1, wherein, the wireless charging device comprises a magnetic induction assembly mounted on a side portion of the battery far away from the connecting member and a controller;
the magnetic induction assembly includes a second support, and a longitudinal section of the second support is I-shaped; the magnetic induction assembly further includes a coil winding on a middle portion of the second support; and the coil is configured for receiving the electromagnetic wave and generating an induction voltage;
the controller includes a control circuit electrically connected to the battery and a wireless charging management circuit connected to the coil, the battery, and the control circuit; and the wireless charging management circuit is configured for rectifying and filtering the induction voltage and providing a rectified and filtered voltage for charging the battery or supplying electric power to the atomizing assembly.

3. The battery assembly according to claim 1, wherein, a guiding groove extending along an axial direction of the connecting member and a fastening groove extending along a circumferential direction of the connecting member and communicating with the guiding groove are defined in an internal surface of the connecting member; and an elastic limiting portion configured for preventing the atomizing assembly from rotating is mounted in the fastening groove.

4. The battery assembly according to claim 2, wherein, a protecting sleeve is mounted in the battery case; the protecting sleeve is made of nonmetallic material; an end of the battery case far away from the connecting member radially extends towards a central axis of the battery case to form an internal flange; the protecting sleeve is resisted between the fixing sleeve and the internal flange; an end surface of the fixing sleeve far away from the protecting sleeve is flush with an end surface of the battery case; one part of the connecting member is accommodated in the fixing sleeve, and another part of the connecting member is accommodated in the protecting sleeve.

5. The battery assembly according to claim 2, wherein, an axis of the coil is parallel to the central axis of the battery case; and the second support is made of ferrite.

6. The battery assembly according to claim 1, wherein, the wireless charging device comprises a magnetic induction assembly mounted on a side portion of the battery far away from the connecting member and a controller;
the magnetic induction assembly includes a cylindrical second support and a coil winding along a circumferential direction of an external surface of the second support; and the coil is configured for receiving the electromagnetic wave and generating an induction voltage;
the controller includes a control circuit electrically connected to the battery and a wireless charging management circuit connected to the coil, the battery, and the control circuit; and the wireless charging management circuit is configured for rectifying and filtering the induction voltage and providing a rectified and filtered voltage for charging the battery or supplying electric power to the atomizing assembly.

7. The battery assembly according to claim 2, wherein, the controller includes an integrated control chip, and the model of the integrated control chip is SG88602; the control circuit and the wireless charging management circuit are integrated in the integrated control chip; a CHG pin of the integrated control chip and a GND pin of the integrated control chip are respectively connected to two terminals of the coil; a VDD pin of the integrated control chip is connected to the anode of the battery, and a GND pin of the integrated control chip is connected to the cathode of the battery.

8. The battery assembly according to claim 2, wherein, the wireless charging management circuit includes a charging management chip, a rectifier diode, and a filter capacitor; and the model of the charging management chip is VA7204;
one terminal of the coil is connected to the anode of the rectifier diode, and the other terminal of the coil is connected to the GND pin of the charging management chip; the cathode of the rectifier diode is connected to the VCC pin of the charging management chip; and the cathode of the rectifier diode is further grounded via the filter capacitor.

9. The battery assembly according to claim 8, wherein, the control circuit includes a microprocessor, a triode, a LED lamp configured for shining to indicate that the wireless connection between the battery assembly and the external charger is normal, and a buzzer configured for generating sounds to indicate that the wireless connection between the battery assembly and the external charger is normal;
the anode of the LED lamp is connected to the cathode of the rectifier diode via a resistor; the anode of the LED lamp is further connected to the microprocessor; the cathode of the LED lamp is grounded; the anode of the buzzer is connected to the cathode of the rectifier diode, and the cathode of the buzzer is connected to the emitter of the triode; the base of the triode is connected to the microprocessor, and the collector of the triode is grounded.

10. The battery assembly according to claim 2, wherein, the battery assembly further includes a charging switch mounted on the battery case and connecting the wireless charging management circuit with the battery; the charging switch is configured for starting a wireless charging function of the battery assembly.

11. An electronic cigarette comprising an atomizing assembly and a battery assembly; the battery assembly configured for cooperating with an external charger to achieve wireless charging; the battery assembly comprising a battery case and a connecting member inserted in an insertion end of the battery case and configured to be connected with the atomizing assembly; a battery configured for charging the atomizing assembly and being mounted in the battery case; wherein, the battery case is made of nonmetallic material; a metallic fixing sleeve is sheathed on the connecting member and inserted in the insertion end of the battery case; and a wireless charging device configured for receiving electromagnetic wave sent from the external charger, and further configured for charging the battery or supplying electric power to the atomizing assembly is mounted in the battery case.

12. The electronic cigarette according to claim 11, wherein, the wireless charging device comprises a magnetic induction assembly mounted on a side portion of the battery far away from the connecting member and a controller;
the magnetic induction assembly includes a second support, and a longitudinal section of the second support is I-shaped; the magnetic induction assembly further includes a coil winding on a middle portion of the second support; and the coil is configured for receiving the electromagnetic wave and generating an induction voltage;
the controller includes a control circuit electrically connected to the battery and a wireless charging management circuit connected to the coil, the battery and the control circuit; and the wireless charging management circuit is configured for rectifying and filtering the induction voltage and providing a rectified and filtered voltage for charging the battery or supplying electric power to the atomizing assembly.

13. The electronic cigarette according to claim 11, wherein, a fastener is mounted on a peripheral surface of an end portion of the atomizing assembly; a guiding groove extending along an axial direction of the connecting member and a fastening groove extending along a circumferential direction of the connecting member and communicating with the guiding groove are defined in an internal surface of the connecting member; the fastener is inserted in the fastening groove, and an elastic limiting portion configured for preventing the atomizing assembly from rotating is mounted in the fastening groove; when the electronic cigarette is assembled, the fastener of the atomizing assembly is inserted in the guiding groove, and when the fastener reaches the connection point of the guiding groove and the fastening groove, the atomizing assembly is rotated so that the fastener enters the fastening groove.

14. The electronic cigarette according to claim 12, wherein, a protecting sleeve is mounted in the battery case; the protecting sleeve is made of nonmetallic material; an end of the battery case far away from the connecting member radially extends towards a central axis of the battery case to form an internal flange; the protecting sleeve is resisted between the fixing sleeve and the internal flange; an end surface of the fixing sleeve far away from the protecting sleeve is flush with an end surface of the battery case; one part of the connecting member is accommodated in fixing sleeve, and another part of the connecting member is accommodated in the protecting sleeve.

15. The electronic cigarette according to claim 12, wherein, the controller includes an integrated control chip, and the model of the integrated control chip is SG88602; the control circuit and the wireless charging management circuit are integrated in the integrated control chip; a CHG pin of the integrated control chip and a GND pin of the integrated control chip are respectively connected to two terminals of the coil; a VDD pin of the integrated control chip is connected to the anode of the battery, and a GND pin of the integrated control chip is connected to the cathode of the battery.

16. The electronic cigarette according to claim 12, wherein, the wireless charging management circuit includes a charging management chip, a rectifier diode, and a filter capacitor; and the model of the charging management chip is VA7204;
one terminal of the coil is connected to the anode of the rectifier diode, and the other terminal of the coil is connected to the GND pin of the charging management chip; the cathode of the rectifier diode is connected to the VCC pin of the charging management chip; and the cathode of the rectifier diode is further grounded via the filter capacitor.

17. A wireless charging method configured for charging a battery assembly, wherein, the wireless charging method comprises: putting the battery assembly in a transmission range of electromagnetic wave sent from an external charger; receiving the electromagnetic wave from the external charger by a wireless charging device mounted in a battery case and charging a battery or supplying electric power to an atomizing assembly by the wireless charging device.

18. The wireless charging method according to claim 17, wherein, receiving the electromagnetic wave from the external charger by the wireless charging device and charging the battery or supplying electric power to the atomizing assembly by the wireless charging device includes: receiving the electromagnetic wave by a coil of a magnetic induction assembly, and generating an induction voltage by the coil; rectifying and filtering the induction voltage by a wireless charging management circuit of a controller, and providing a rectified and filtered voltage for charging the battery or supplying electric power to the atomizing assembly by the wireless charging management circuit.

19. The wireless charging method according to claim 17, wherein, the wireless charging method further comprises: turning on a charging switch mounted on the battery case before starting a wireless charging function of the battery assembly.

20. The wireless charging method according to claim 17, wherein, the wireless charging method further comprises: after the battery assembly is put in the transmission range of the electromagnetic wave sent from the external charger, if the wireless connection between the battery assembly and the external charger is normal, starting to charge the battery or supplying the atomizing assembly with the electric power, and indicating the normal wireless connection by shining and/or making sounds.
